(19) United States
(12) Patent Application Publication
(10) Pub. No.: US 2014/0305978 A1
(43) Pub. Date: Oct. 16, 2014

(54) Rack System

(71) Applicant: Vincent Bernard Austrie, Stamford, CT (US)

(72) Inventor: Vincent Bernard Austrie, Stamford, CT (US)

(21) Appl. No.: 14/159,997

(22) Filed: Jan. 21, 2014

Related U.S. Application Data
(60) Provisional application No. 61/754,770, filed on Jan. 21, 2013.

(51) Int. Cl. B60R 9/06

(52) U.S. Cl. CPC B60R 9/06
USPC 224/405

(57) ABSTRACT

A rack system to provide a rack on top of two opposite side walls.

### CROSS-REFERENCE TO RELATED APPLICATIONS

This application claims priority from U.S. provisional patent application Ser. No. 61/754,770, which was filed on Jan. 21, 2013.

### BACKGROUND OF THE INVENTION

1. Field of the Invention

The present invention provides for a rack system hat comprises a stable rack on top of two opposite side walls.

2. Description of the Related Art

Pickup trucks include beds positioned behind the operator's cabin or cab. The beds are used for carrying various types of cargo. Oftentimes, an owner of a pickup truck will install or have installed a cover over the bed of the pickup truck. The cover may be a “hard” cover that extends above the top of the sidewalls of the bed or it may be a “soft” cover, The purpose of the bed cover is to protect the bed and any items carried in the bed from the elements. The bed cover generally cannot provide a platform to carry additional cargo.

Alternatively, an owner of a pickup truck may install or have installed a utility rack for additional carrying capacity. Most known utility racks mount to the pickup truck by mechanisms that require drilling, welding or other modifications to the horizontally displaced load bearing bed and/or the upstanding forward wall, sidewalls and rear tailgate portions of the rear cargo area.

### SUMMARY OF THE INVENTION

The present invention provides for a rack system that comprises a stable rack on top of two opposite side walls. The system is useful in making a temporary rack or platform for construction or transport of cargo. More particularly, the rack system may be used to convert the back of a pickup truck that has side walls to a flatbed. Such a flatbed is useful in securely carrying more load than can be carried in an unmodified pickup truck. Advantageously, the present rack system ay be quickly and easily installed and removed from the pickup truck.

The following describes the basic features of the rack system of the present invention.

The rack system is capable of providing a stable rack on top of two opposite side walls. The rack system comprises at least two members, each member comprising a first L-shaped bracket having a vertical flat arm and a horizontal flat arm, and a second U-shaped bracket attached to the side of the vertical flat arm of the first L-shaped bracket; and a brace extending from one side wall to the opposite side wall, wherein each end of the brace is held by the second U-shaped bracket of a member and the horizontal flat arm of each member is supported on top of the side walls.

The various features of novelty which characterize the invention are pointed out with particularity in the claims annexed to and forming a part of the disclosure, For a better understanding of the invention, its operating advantages, and specific objects attained by its use, reference should be had to the drawing and descriptive matter in which there are illustrated and described preferred embodiments of the invention.

Other objects and features of the present invention will become apparent from the following detailed description considered in conjunction with the accompanying drawings, it is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 shows a perspective schematic of the member of the present invention.

FIGS. 2-8 show various perspectives of a rack system having three racks.

FIGS. 5 and 9 are close-up views of a member, wherein the horizontal flat arm of the L-shape bracket of the member is supported on top of the side wall.

FIGS. 10 and 11 are close-up views of a member, wherein a locking unit has two screws on both sides.

FIG. 12 shows the second U-shaped bracket having one hole on opposite sides, and the holes are capable of receiving a locking pin to secure the brace to the second U-shaped bracket.

FIG. 13 shows the rack system without a sheet placed on top so that items below the rack system may be accessible.

### DETAILED DESCRIPTION OF THE PRESENTLY PREFERRED EMBODIMENTS

In one preferable embodiment, the rack system of the present invention comprises two racks capable of holding a sheet so as to form a flatbed.

The rack system may have a locking unit adjacent to the horizontal flat arm that locks the member to the top of the side wall.

In another embodiment, the second U-shaped bracket of at least one member of the rack system has at least one hole on opposite sides and the end of the brace has a hole that aligns with the holes on the sides the second U-shaped bracket, and the holes are capable of receiving a locking pin to secure the brace to the second U-shaped bracket.

In another embodiment, the second U-shaped bracket of at least one member of the rack system has at least one hole on the bottom and the end of the brace has a hole that aligns with the hole on the bottom of the second U-shaped bracket, and the holes are capable of receiving a locking pin or screw to secure the brace to the second U-shaped bracket.

In still another embodiment, at least one member of the rack system is attached to the side wall by a locking unit so as to secure the member to the side wall. In one preferred manner, the locking unit comprises a screw that secures the vertical flat arm of the first L-shaped bracket to the side wall.

The present invention can be best understood in connection with the accompanying drawings. It is noted that the invention is not limited to the precise embodiments shown in the drawing.

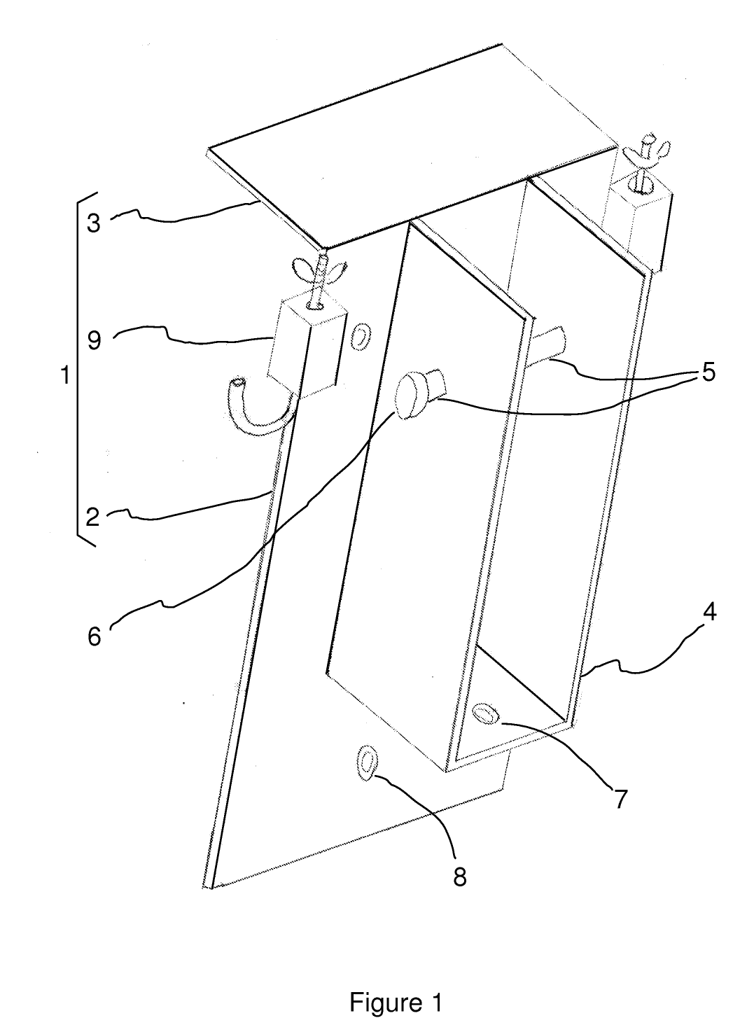

FIG. 1 shows a perspective schematic of the member of the present invention comprising a first L-shaped bracket (1) having a vertical flat arm (2) and a horizontal flat arm (3), and a second U-shaped bracket (4) attached to the side of the vertical fiat arm of the first L-shaped bracket.

When the member is used in forming the rack system between two side walls, the horizontal flat arm (3) is supported on top of the side wall. A brace extends from one side wall to the opposite side wall, wherein each end of the brace is held by the second U-shaped bracket of a member.

Preferably, the second U-shaped bracket has at least one hole on opposite sides (5) and the end of the brace has a hole that aligns with the holes on the sides the second U-shaped bracket, and the holes are capable of receiving a locking pin (6) to secure the brace to the second U-shaped bracket.

Alternatively or in addition to the above manner of securing the brace to the second U-shaped bracket, the second U-shaped bracket has at least one hole on the bottom (7) and the end of the brace has a hole that aligns with the hole on the bottom of the second U-shaped bracket, and the holes are capable of receiving a locking pin or screw to secure the brace to the second U-shaped bracket.

A member may be attached to the side wall by a locking unit. Such a locking unit may comprise a screw that secures the vertical flat arm of the first L-shaped bracket to the side wall. The screw may pass through the hole (8) of the vertical flat arm (2) into the side wall.

Alternatively, if the top of the side wall has a lip that extends from the side wall, a member may be attached to the side wall by a second locking unit. In one embodiment, such a locking unit comprises a clamp (9) that secures the horizontal flat arm of the first L-shaped bracket to the lip of the side wall.

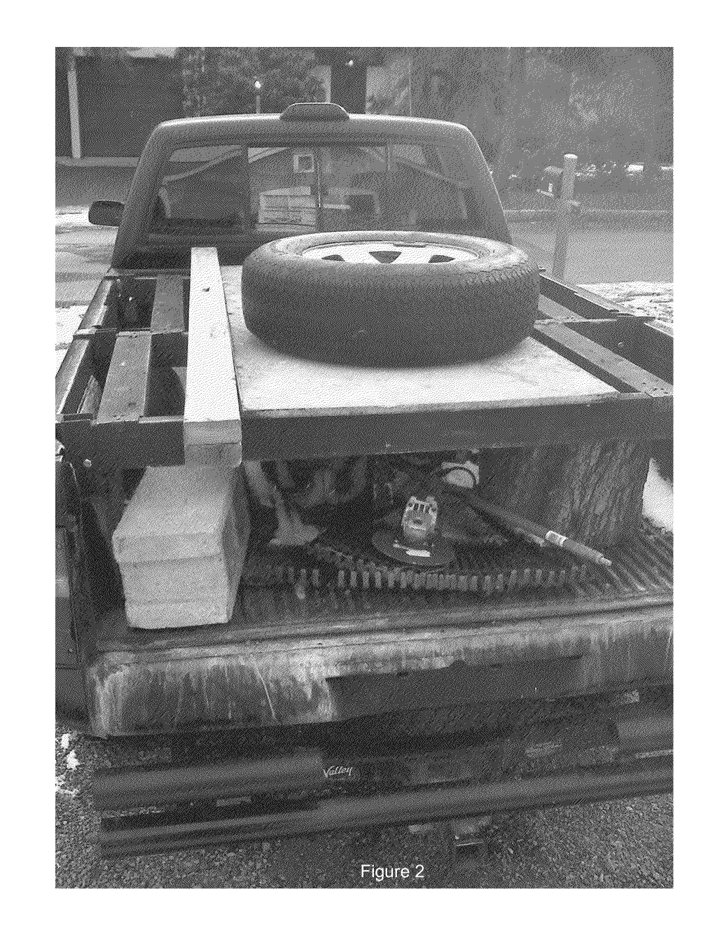

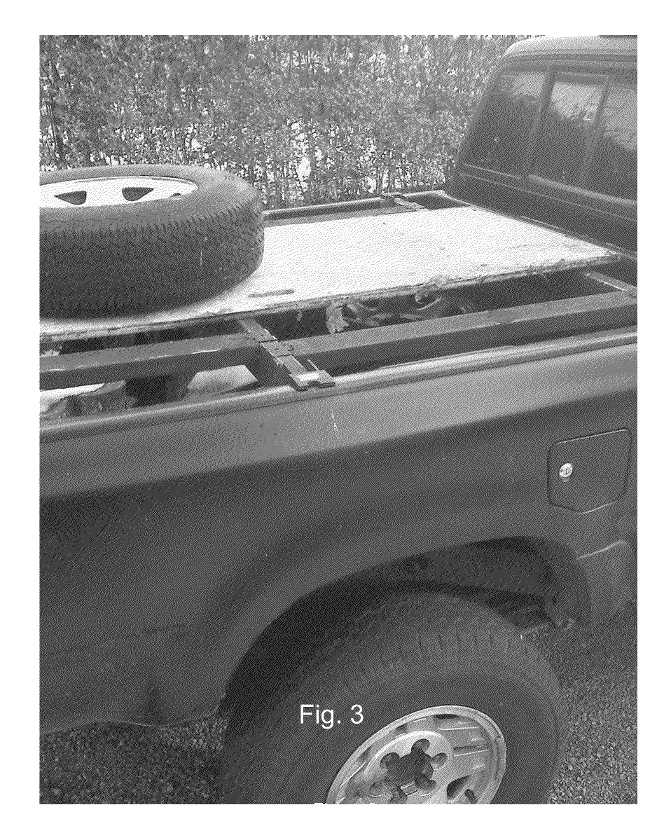

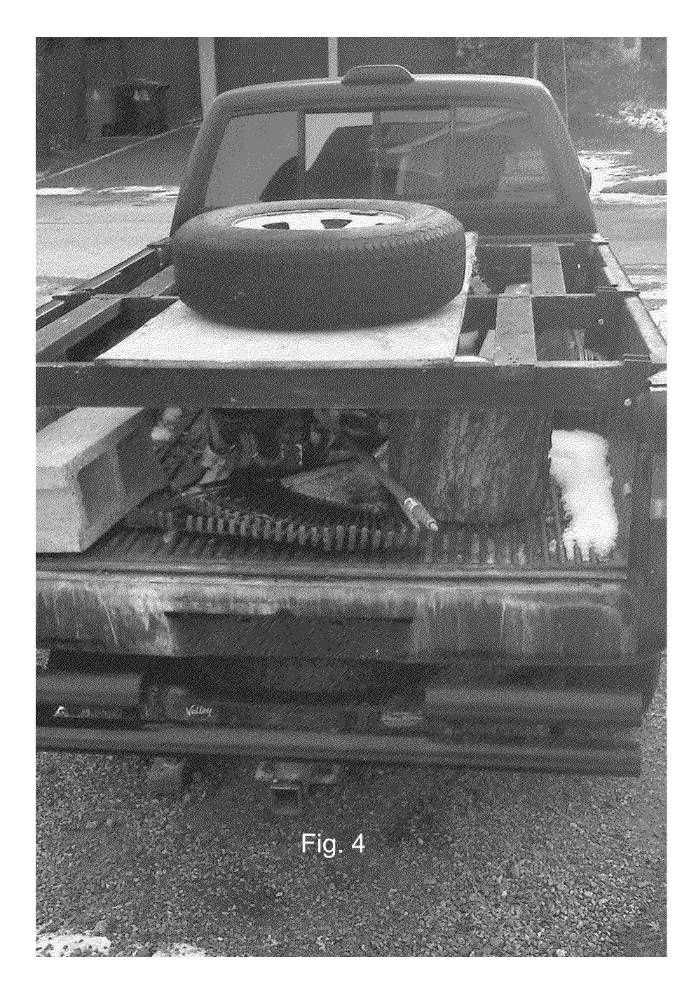

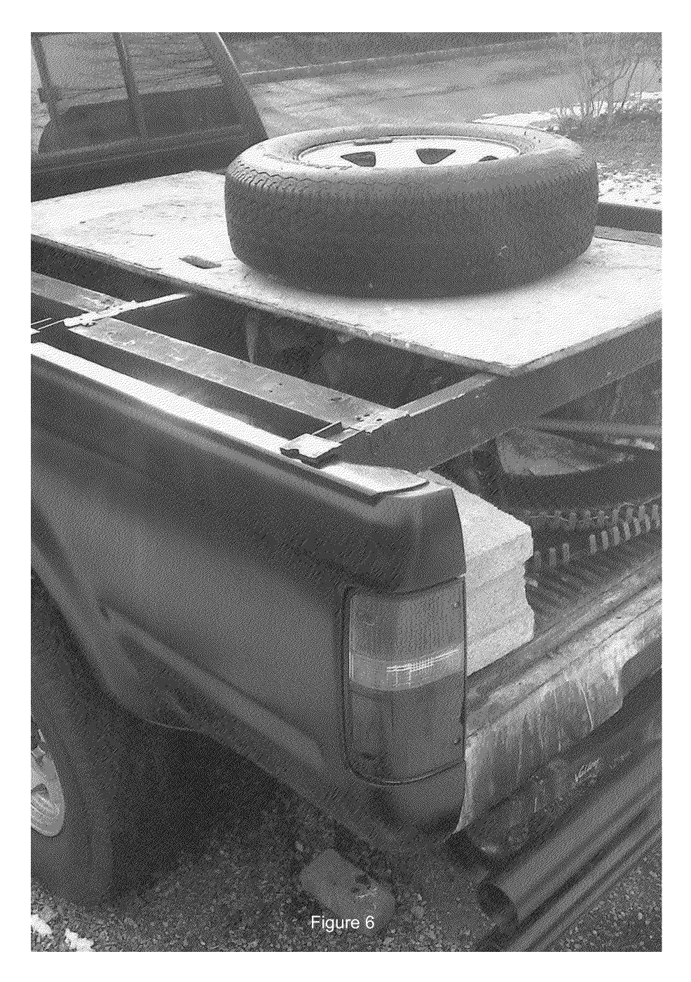

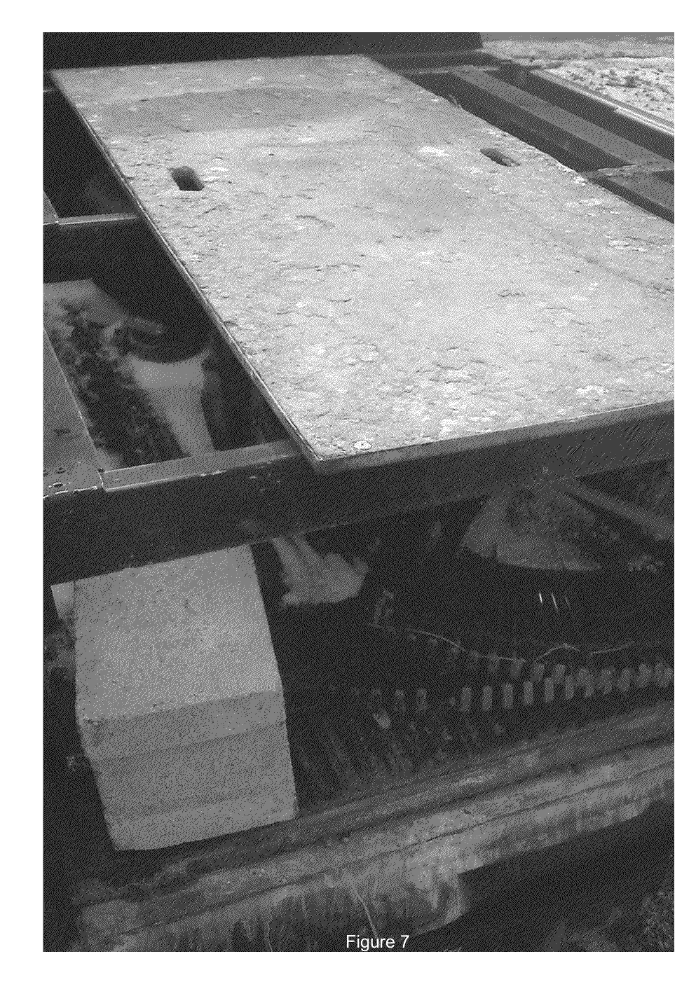

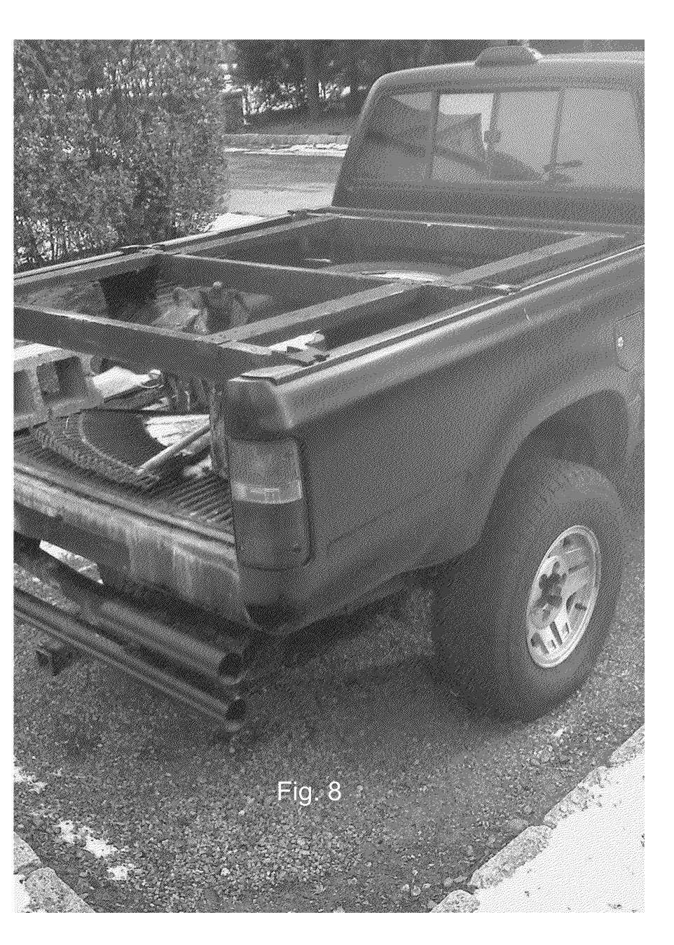

FIGS. 2-13 shows how the member is used to form the flatbed on a pickup truck, comprising at least two racks capable of holding a sheet. Each rack comprises a pair of members and a brace that is secured between the two members.

FIGS. 2-8 show various perspectives of a rack system having three racks. Each rack has two members attached to the opposite side walls of the back of a pickup truck with a brace that is held by the two members. The three braces are attached together with cross bracings. A plywood sheet is placed on top of the rack system to provide a platform.

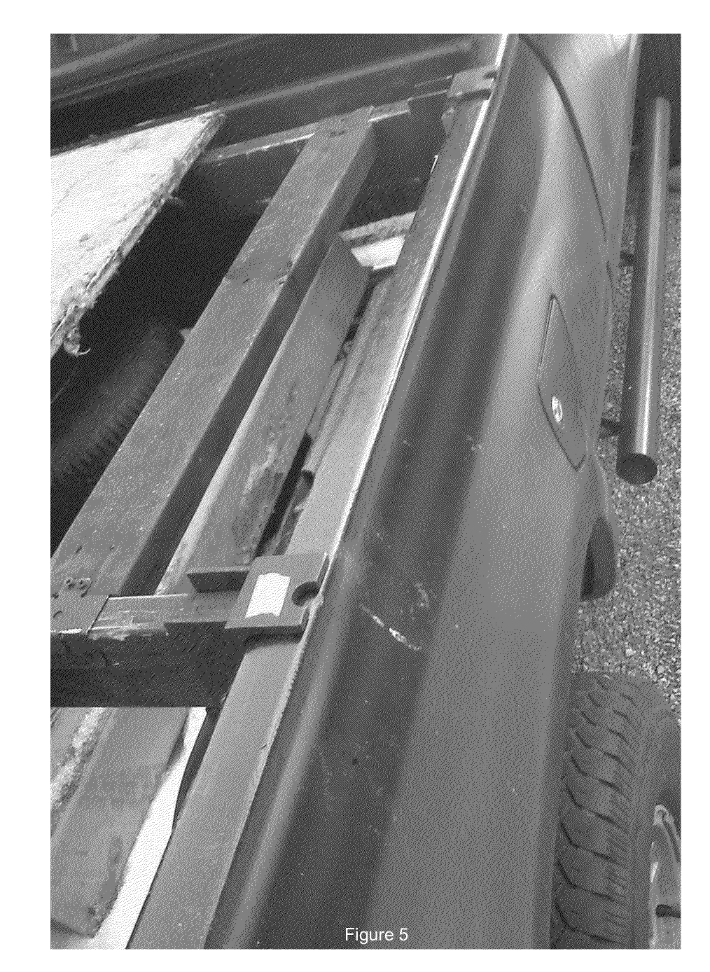

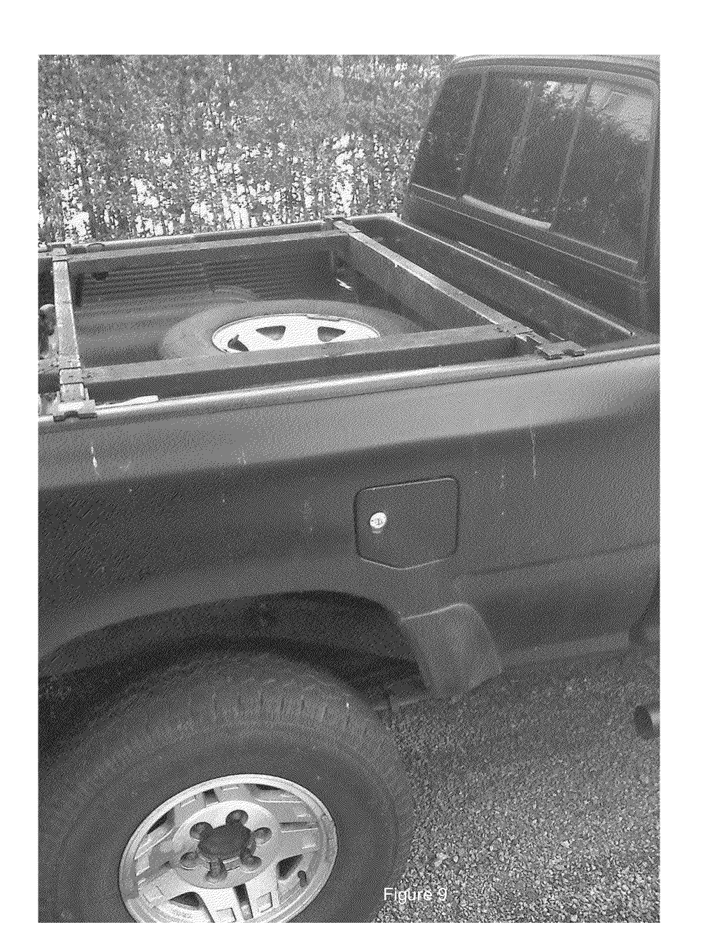

FIGS. 5 and 9 are close-up views of a member, wherein the horizontal flat arm of the L-shape bracket of the member is supported on top of the side wall, A wood brace extends from one side wall to the opposite side wall, wherein each end of the brace is held by the second U-shaped bracket of a member.

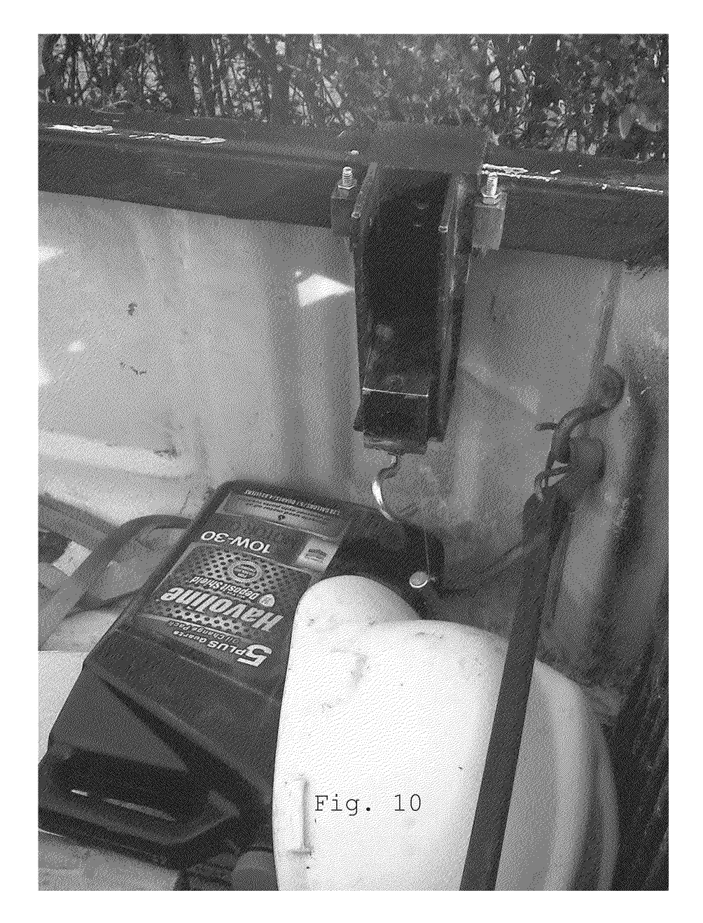

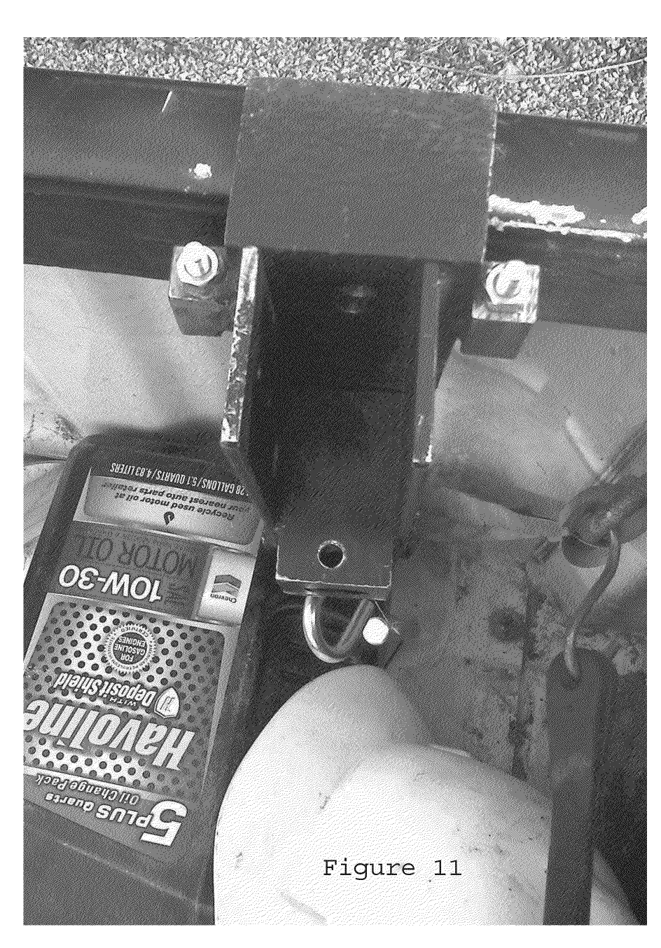

FIGS. 10 and 11 are close-up views of a member, wherein a locking unit has two screws on both sides of the second U-shaped bracket of the member that secure the first L-shaped bracket to the side wall.

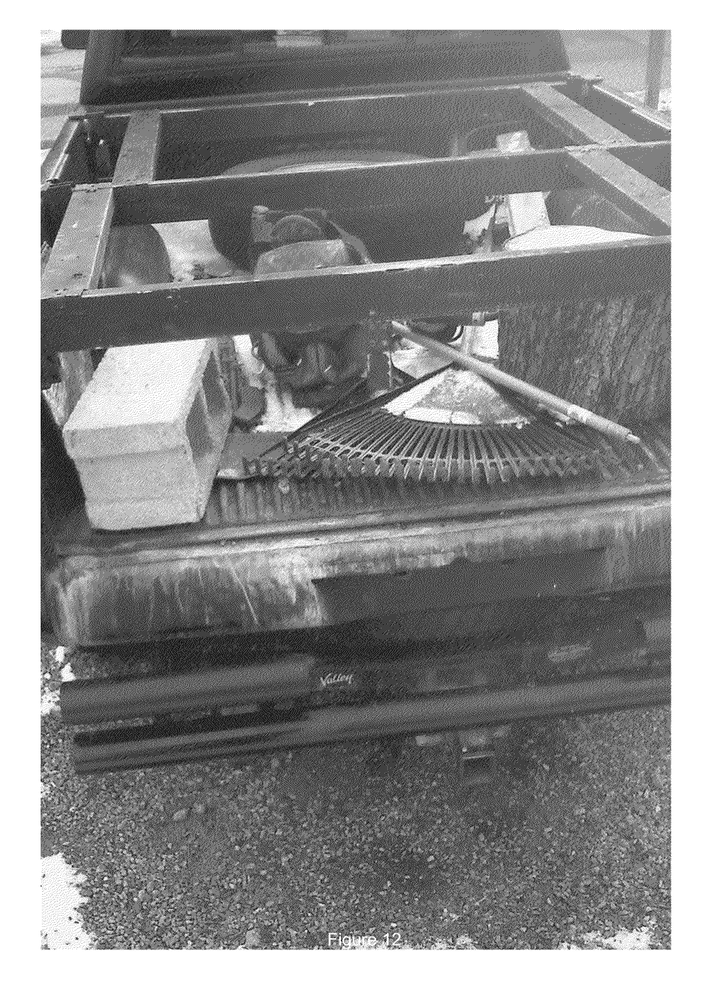

FIG. 12 shows the second U-shaped bracket having one hole on opposite sides and the end of the brace has a hole that aligns with the holes on the sides the second U-shaped bracket, and the holes are capable of receiving a locking pin to secure the brace to the second U-shaped bracket.

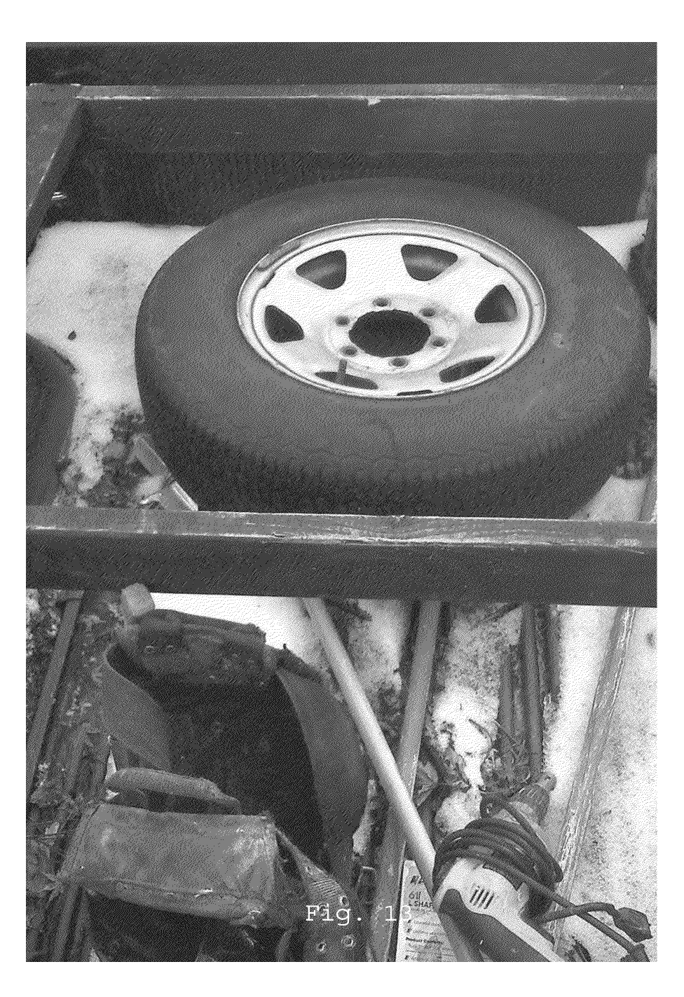

FIG. 13 shows the rack system without a sheet placed on top so that items below the rack system may be accessible.

The invention is not limited by the embodiments described above which are presented as examples only but can be modified in various ways within the scope of protection defined by the appended patent claims.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A rack system to provide a rack on top of two opposite side walls comprising:
at least two members, each member comprising a first L-shaped bracket having g a vertical flat arm and a horizontal flat arm, and a second U-shaped bracket attached to the side of the vertical flat arm of the first L-shaped bracket;
a brace extending from one side wall to the opposite side wall, wherein each end of the brace is held by the second U-shaped bracket of a member and the horizontal flat arm of each member is supported on top of the side walls.

2. The rack system of claim 1 comprising two racks capable of holding a sheet so as to form a flatbed.

3. The rack system of claim 1, wherein a locking unit is attached to the member and locks the member to the top of the side wall.

4. The rack system of claim 1, wherein the second U-shaped bracket has at least one hole on opposite sides and the end of the brace has a hole that aligns with the holes on the sides the second U-shaped bracket, and the holes are capable of receiving a locking pin to secure the brace to the second U-shaped bracket.

5. The rack system of claim 1, wherein the second U-shaped bracket has at least one hole on the bottom and the end of the brace has a hole that aligns with the hole on the bottom of the second U-shaped bracket, and the holes are capable of receiving a locking pin or screw to secure the brace to the second U-shaped bracket.

6. The rack system of claim 1, wherein at least one member is attached to the side wall by a locking unit.

7. The rack system of claim 6, wherein the locking unit comprises a screw that secures the vertical flat arm of the first L-shaped bracket to the side wall.
